(19) United States
(12) Patent Application Publication
(10) Pub. No.: US 2026/0334516 A1
(43) Pub. Date: Oct. 29, 2026

(54) POPCORN MACHINE

(71) Applicant: Wolfgang Jodlbauer, Fürstenzell (DE)

(72) Inventor: Wolfgang Jodlbauer, Fürstenzell (DE)

(21) Appl. No.: 19/565,860

(22) Filed: Mar. 13, 2026

(30) Foreign Application Priority Data
Apr. 23, 2025 (EP) 25 171 973.8

(51) Int. Cl. A23L 7/187

(52) U.S. Cl. CPC A23L 7/187

(57) ABSTRACT

A popcorn machine for producing popcorn from corn includes a heating unit (4) with a heating element (10) and a popping unit (6). The popping unit (6) is pivotably connected to the heating unit (4) via a pivoting unit in such a manner that the popping unit (6) is pivotable between a first pivot position, in which the popping unit (6) rests on the heating element (10) in particular, and a second pivot position, in which the popping unit (6) is spaced apart from the heating element (10). The popping unit (6) includes a base trough (12) which is detachably fixed to an annular body (14) of the popping unit (6).

This application claims the benefit of European patent application no. 25 171 973.8, filed Apr. 23, 2025, the disclosure of which is incorporated herein by reference.

### TECHNICAL FIELD

The present invention relates to a popcorn machine for producing popcorn from popcorn kernels, the popcorn machine comprising a heating unit and a popping unit.

### BACKGROUND

Various designs of popcorn machines are known from the state of the art. Known popcorn machines generally comprise a popping unit and a heating unit. The popping unit is filled with corn. Subsequently, the popping unit is heated by means of the heating unit in such a manner that the corn bursts or pops to popcorn. Known popping units are generally designed in the form of a one-piece container, which has an opening for inserting the corn and for dispensing the popcorn. The opening is kept small in order to prevent or at least reduce unwanted spillage of popcorn, especially during popcorn production. The one-piece design of the popping unit and its small opening make cleaning the popping unit difficult.

The object of the present invention is to propose a popcorn machine which can be cleaned easily.

### SUMMARY

According to the invention, a popcorn machine for producing popcorn from corn is provided, said popcorn machine comprising a heating unit with a heating element and a popping unit. The popping unit is connected to the heating unit via a pivoting unit so as to be pivotable between a first pivot position and a second pivot position. In the first pivot position, the popping unit rests on the heating element of the heating unit in particular, or is disposed close to the heating element, in particular closer than in the second pivot position, such that the popping unit can be heated by means of the heating element. In the second pivot position, the popping unit is spaced apart from the heating element, in particular further than in the first pivot position. The popping unit has a base trough, which is detachably fixed to an annular body of the popping unit.

By pivotably connecting the popping unit to the heating unit, the popping unit is easily pivotable between the first position and the second position in a defined manner. Thus, in the first position, in which the popping unit is in contact with the heating unit, popcorn can be made of corn, the produced popcorn then being dispensed from the popping unit by pivoting the popping unit relative to the heating unit. In addition, by pivotably connecting the heating unit to the popping unit, in particular to the annular body of the popping unit, the base trough of the popping unit can be accessed, such that said base trough, which is detachably fixed to the annular body, can be removed from the annular body. When not installed, the base trough can be easily cleaned.

In the first pivot position, the popping unit, in particular the base trough, is disposed in an indentation of the heating unit, for example.

For example, the indentation can be limited by the heating element at the bottom. Thus, the heating element can be accessed via the indentation or exposed at the top, i.e., on the heating side.

In the second pivot position, the popping unit is in particular fully removed from the indentation, for example.

For example, the geometry of the indentation corresponds to a geometry of the popping unit, in particular the base trough. In particular, the base trough is partly or fully disposed in the indentation when the popping unit is in the first pivot position.

The heating element can be a ceramic glass cooktop. Any other heating elements are also conceivable.

In an exemplary embodiment of the popcorn machine according to the invention, the base trough rests in surface contact on the heating element in the first pivot position.

In an exemplary embodiment of the popcorn machine according to the invention, the heating element is elastically mounted on a housing of the heating unit.

For example, the heating element is elastically mounted on the housing vita at least one bearing. Two, three or four bearings can be provided for fixedly and elastically mounting the heating unit on the housing, the heating element resting on said bearings, in particular in edge portions.

For example, the bearings are configured such that they allow a movement of the heating element along a defined path in a direction orthogonal to a transverse extension plane of the heating element, in particular in the vertical direction of the popcorn machine.

The at least one bearing comprises a spiral spring, for example. A first end of the spiral spring can be fixed to the housing; i.e., it cannot be displaced relative to the housing of the heating unit. The second end of the spiral spring can directly or indirectly rest on the heating element.

For example, the at least one bearing rests on a bearing plate, which is rigidly fixed to the housing and which extends in particular parallel to the heating element. It is also conceivable that the at least one bearing element rests on a housing protrusion.

In a preferred embodiment of the popcorn machine according to the invention, the pivoting unit engages with the annular body. This means that the popping unit does not need to be removed from the heating unit in order to clean the base trough. Rather, when the heating unit is in the second pivot position, the base trough can be easily detached from the annular body and then cleaned.

For example, the pivoting unit comprises at least one hinge, in particular two hinges, or is made of it/them.

In an exemplary embodiment of the popcorn machine according to the invention, the popping unit comprises a lid.

The lid can be fixed to the annular body so as to be detachable.

For example, the lid seals the annular body on a side opposite the base trough.

The lid can be fastened to the annular body by means of a fastening arrangement, for example.

The fastening arrangement can comprise at least one thread screw, which is pivotably mounted on the annular body or the lid, and onto which a nut is screwed, the lid or the annular body comprising at least one fastening element receptacle. The fastening element receptacle has a side notch, into which the screw can be inserted. By screwing the nut onto the screw until the nut rests on the mounting receptacle, the lid is detachably fixed to the annular body.

In a preferred embodiment of the popcorn machine according to the invention, the popping unit comprises a stirring unit and a drive unit for driving the stirring unit.

The stirring unit can be disposed in a popping space, which is defined by the base trough, the annular body and/or the lid.

For example, the stirring unit comprises a drive shaft connected to the drive unit, in particular detachably or fixedly connected to the drive unit.

The popping unit can comprise a temperature sensor by means of which in particular a temperature of the base trough can be detected.

For example, the temperature sensor rests on the base trough when the popping unit is assembled.

The temperature sensor can be rigidly fixed to the stirring unit, in particular to the drive shaft, preferably on an end of the drive shaft facing away from the drive unit, or the temperature sensor can be mounted on the drive shaft so as to be movable.

For example, the drive shaft is a hollow pipe, which is open, in particular at least on one end facing away from the drive unit, or comprises an opening through which the temperature sensor can at least partly exit or protrude.

A spring element, in particular in the form of a spiral spring, can be disposed in the hollow pipe. For example, the spring element applies a (compression) force acting in the direction of the base trough to the temperature sensor. This ensures that the temperature sensor is in the intended measuring position, in particular that it rests on the base trough and/or is located close to the base trough.

For example, the spring element and/or the temperature sensor is disposed in a guide pipe, which is in particular fixedly connected to the drive shaft.

For example, the guide pipe is disposed in the hollow pipe, in particular in such a manner that their central axes correspond. Thus, the guide pipe has a smaller diameter than the hollow pipe, for example.

The stirring unit can have at least one stirring element which extends in particular in the transverse direction of the popping unit.

For example, the transverse direction of the popping unit corresponds to the transverse direction of the popcorn machine, when the popping unit is in the first pivot position.

For example, the at least one stirring element is fastened to the drive shaft, in particular so as to be detachable or fixed. It is also conceivable that the at least one stirring element and the drive shaft are formed in one piece.

The stirring element can extend orthogonally to the drive shaft.

For example, the stirring unit comprises two, three or four stirring elements, which are connected to each other in particular via a connecting element.

For example, the connecting element can be detachably connected to the drive shaft; in particular, it can be slid onto an end of the drive shaft and preferably be locked in place.

In a preferred embodiment of the popcorn machine according to the invention, the drive unit is provided on or in the lid. For example, the drive unit can be disposed on a side of the lid facing away from the annular body, or said drive unit can be fully enclosed by the lid. Thus, when the popping unit is pivoted relative to the heating unit, the drive unit can continue to drive the stirring unit, in particular rotate the stirring unit. This facilitates dispensing the popcorn from the popping unit.

In an exemplary embodiment of the popcorn machine according to the invention, the annular body comprises an opening, in particular a side opening, for dispensing popcorn from the popping unit.

The opening has a U-shaped or semicircular profile, for example.

The opening can extend up to an end of the annular body facing the lid.

The opening can be sealed with a sealing element, for example. The sealing element can be designed as a thin sheet.

The sealing element can be mounted on the lid so as to be pivotable between a sealed position, in which the opening is sealed, and an open position, in which the opening is open, in particular by means of hinges.

In a preferred embodiment of the popcorn machine according to the invention, the sealing element is mounted on the lid in such a manner that pivoting the popping unit from the first position to the second position causes a pivoting of the sealing element from the sealed position to the open position. Thus, the opening is automatically exposed when the popping unit is pivoted to the second pivot position.

In an exemplary embodiment, the popcorn machine according to the invention comprises a gas spring for supporting a pivoting motion of the popping unit.

For example, the gas spring is disposed in the housing of the heating unit.

A first end of the gas spring can be fixed to the housing, in particular in such a manner that said gas spring is rotatable around a single axis relative to the housing, but not translationally moveable relative to the housing.

For example, the second end of the gas spring is connected to the popping unit, in particular the annular body, via a deflection arrangement in such a manner that the gas spring supports a pivoting of the popping unit from the first pivot position to the second pivot position, i.e., applies a force to the popping unit which acts in the direction of the second pivot position.

The second end of the gas spring can be connected to the popping unit, in particular the annular body, via the deflection arrangement in such a manner that the deflection arrangement cushions a pivoting of the popping unit to the first pivot position, i.e., applies a force to the popping unit which acts in the opposite direction of the pivoting motion from the second pivot position to the first pivot position.

For example, the gas spring is connected to the popping unit via the deflection arrangement in such a manner that a pivoting of the popping unit from the second pivot position to the first pivot position causes the gas spring to be tensioned.

The popcorn machine can comprise a pivot lever for pivoting the popping unit between the first pivot position and the second pivot position.

The pivot lever is rotatably mounted on the housing, for example.

A force transmitted to the pivot lever can be transmitted to the popping unit, in particular to the annular body, via the deflection arrangement or via an additional deflection arrangement, for example.

In an exemplary embodiment, the popcorn machine according to the invention comprises a cooling fan. For example, the cooling fan is a component of the heating unit. The cooling fan can be provided inside the housing, in particular in the center of the housing.

In a preferred embodiment, the popcorn machine according to the invention comprises a programmable logic controller (PLC).

For example, the programmable logic controller can store popcorn recipes and/or stored popcorn recipes can be executed by means of the programmable logic controller.

For example, a temperature of the heating element can be controlled by means of the programmable logic controller, in particular to within one degree, and/or a speed of the stirring unit can be controlled by means of the programmable logic controller.

For example, the control unit is connected to the temperature sensor in such a manner that the control unit controls the temperature of the heating element while taking into account the temperature detected by the temperature sensor.

For example, the programmable logic controller is configured such that it controls the temperature of the heating unit and/or the speed of the stirring unit on the basis of the stored recipes.

In a preferred embodiment, the popcorn machine according to the invention comprises a control panel. For example, the control panel is connected to the programmable logic controller in such a manner that information of the programmable logic controller can be displayed on the control panel and/or information entered into the control panel by the user can be transmitted to the programmable logic controller.

For example, recipes stored on the programmable logic controller can be displayed on the control panel. The recipes can comprise individual instructions, which are displayed on the control panel, in particular in the corresponding chronological order.

For example, the programmable logic controller is configured such that it only displays information on the control panel which requires the user to take action. Other information which does not require a user to take action, such as setting the temperature of the heating element and/or setting a speed of the stirring unit on the basis of a selected, stored recipe, for example, the programmable logic controller executes directly.

Information requiring the user to take action is, for example, which source product is to be filled into the popping unit, in particular in connection with an indication of quantity.

Recipes to be stored can be entered into the programmable logic controller via the control panel.

Recipes stored on the programmable logic controller can be selected, changed and/or deleted via the control panel, for example.

### BRIEF DESCRIPTION OF DRAWINGS

Hereinafter, the invention will be described in more detail by means of an embodiment shown in the drawing.

FIG. 1 shows a perspective view of a popcorn machine according to the invention;

FIG. 2 shows a front view of the popcorn machine from FIG. 1;

FIG. 3 shows a sectional view through the popcorn machine from FIG. 2 along the line III-III;

FIG. 4 shows a view corresponding to FIG. 1, a popping unit of the popcorn machine being in a second pivot position;

FIG. 5 shows an exploded view of the popping unit; and

FIG. 6 shows a detailed view of the area A in FIG. 3.

### DETAILED DESCRIPTION

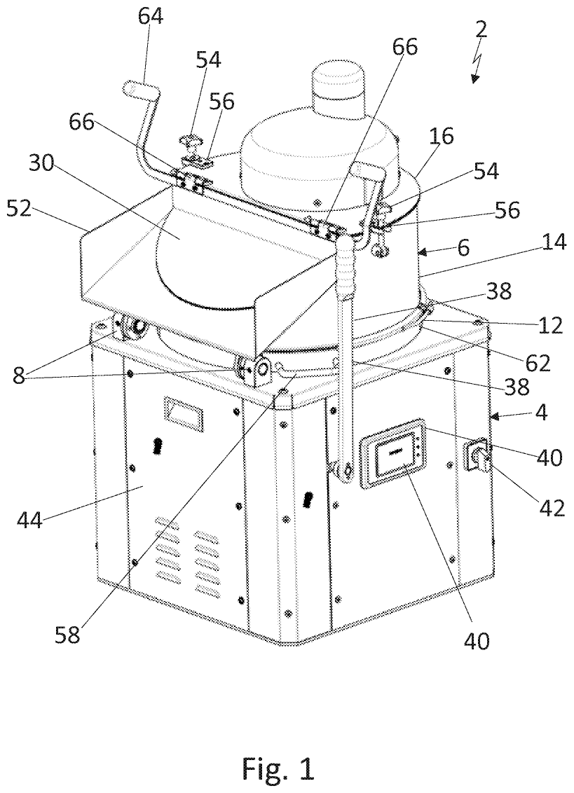

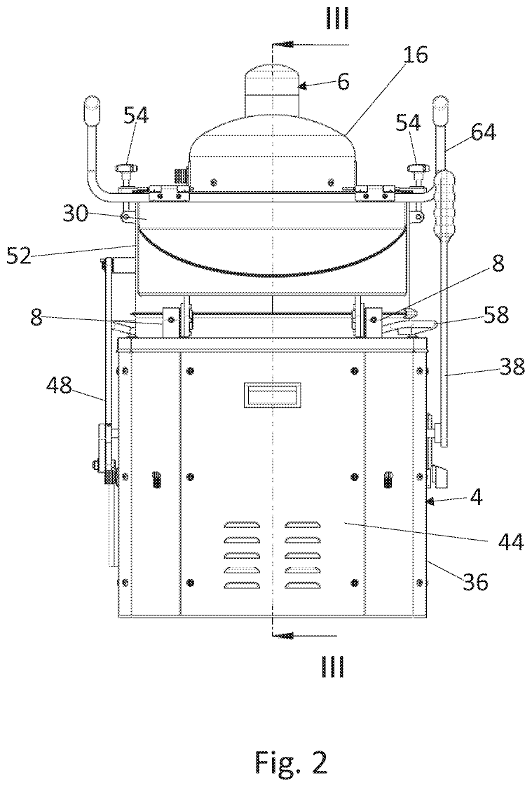

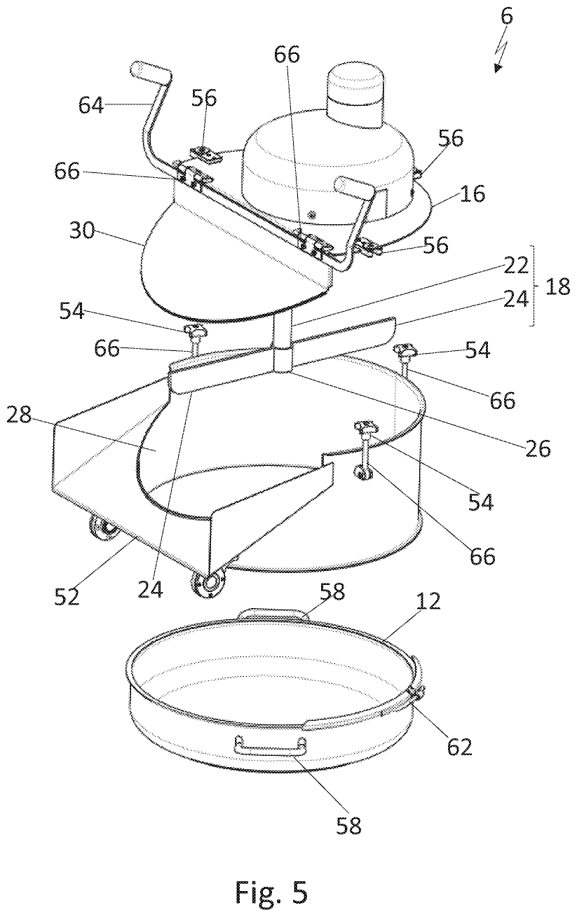

FIGS. 1 to 4 show a popcorn machine 2 according to the invention. Popcorn machine 2 comprises a heating unit 4 and a popping unit 6. FIG. 5 shows an exploded view of popping unit 6.

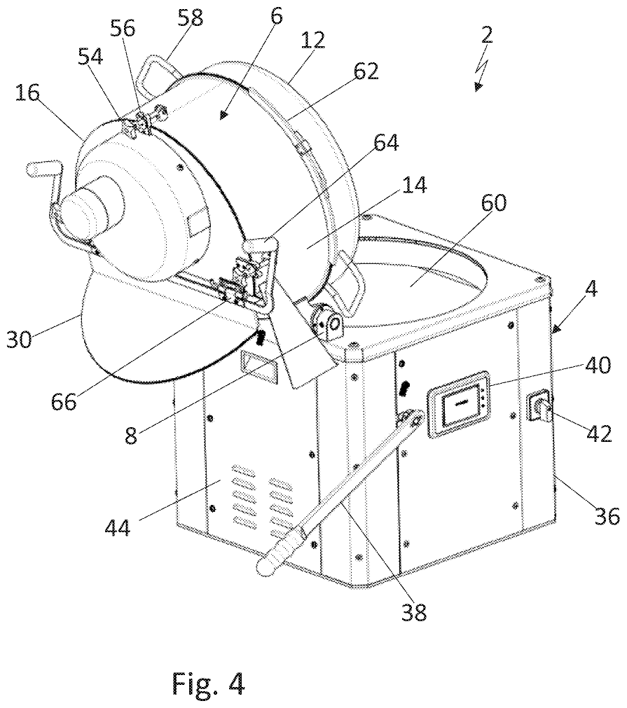

Popping unit 6 is mounted on heating unit 4 so as to be pivotable between a first pivot position, which is shown in FIGS. 1 to 3, and a second pivot position, which is shown in FIG. 4, via a pivoting unit. The pivoting unit is made of two pivot bearings 8. The two pivot bearings 8 allow popping unit 6 to pivot around a single axis relative to heating unit 4. As can be seen in particular in FIGS. 4 and 5, popping unit 6 has an annular body 14 at which it is pivotably mounted. Thus, pivot bearings 8 engage with annular body 14 of popping unit 6.

Popping unit 6 comprises a base trough 12 and a lid 16. Base trough 12 seals annular body 14 at a first end in the axial direction of the annular body. Base trough 12 is detachably fixed to annular body 14 by means of a fastening element 62. For easier handling, base trough 12 comprises base trough handles 58.

Lid 16 seals annular body 14 on the end which is second in the axial direction of the annular body and which is opposite the first end. Lid 16 is detachably fixed to annular body 14 via a fastening arrangement. The fastening arrangement comprises three thread screws 68, which are rotatably mounted on annular body 14 and on each of which a nut 54 can be screwed. Furthermore, the fastening arrangement comprises fastening element receptacles 56, which are rigidly fixed to lid 16. For fixing lid 16 to annular body 14, thread screws 68 are rotatable in such a manner that they each extend through a corresponding fastening element receptacle 56. Then, nuts 54 are screwed onto thread screws 68 in such a manner that nuts 54 rest on fastening element receptacles 56. Thus, the lid 16 is detachably fixed to annular body 14, in particular in a force-fitting and/or form-fitting manner.

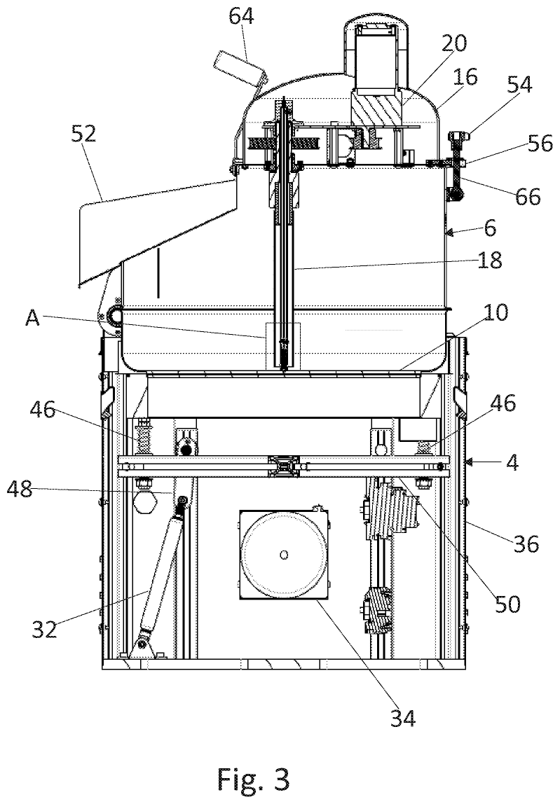

As can be seen from FIG. 3, a drive unit 20 for a stirring unit 18 is provided in lid 16. Stirring unit 18 is disposed in a popping space defined by base trough 12, annular body 14 and lid 16. Stirring unit 18 comprises a drive shaft 22, which extends in the axial direction of the annular body, and two stirring elements 24 extending orthogonally to drive shaft 22. Stirring elements 24 are connected to each other via a connecting element 26. Connecting element 26 is slid onto an end of drive shaft 22 facing away from drive unit 20 and interlocked with said drive shaft 22 in particular so as to be detachable.

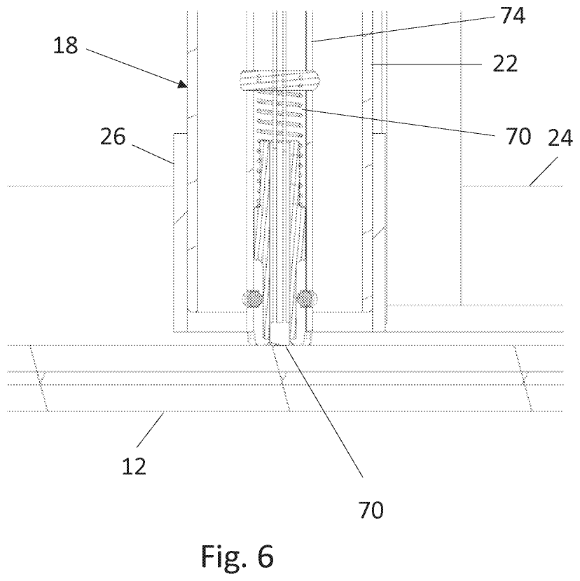

As can be seen in FIG. 6 from the detailed view of area A in FIG. 3, drive shaft 22 is configured in the form of a hollow pipe which is open at an end facing away in the axial direction of the drive shaft of drive unit 20.

A guide pipe 74 is disposed in drive shaft 22. Guide pipe 74 is also formed as a hollow pipe, which is open at an end facing away from drive unit 20. At the end facing drive unit 20, guide pipe 74 is fixedly connected or fixed to drive shaft 22, in particular in such a manner that a longitudinal center axis of drive shaft 22 corresponds to a longitudinal center axis of guide pipe 74.

In guide pipe 74, a temperature sensor 70 is movably disposed in such a manner that it can be moved translationally in a single direction, in particular in the axial direction of the drive shaft. Preferably, temperature sensor 70 is movably disposed in such a manner that it can at least slightly exit through the open end of drive shaft 22, such that it protrudes from drive shaft 22 and can rest on base trough 12.

Further, a spring element 72, in particular a spiral spring, is provided in drive shaft 22, said spiral spring applying a force acting in the direction of the open end of drive shaft 22 to temperature sensor 70. Spring element 72 is preferably configured such that it presses temperature sensor 70 against base trough 12. In this manner, spring element 72 ensures that there is sufficient contact between temperature sensor 70 and base trough 12 for temperature measuring.

To bring out the popcorn formed in the popping unit 6, the annular body 14 has a side opening 28. A discharge ramp 52 is adjacent to the opening 28.

A sealing element 30 is provided for closing opening 28. Sealing element 30 is mounted on lid 16, in particular by means of two hinges 66, so as to be pivotable between a sealed position, in which opening 28 is sealed, and an open position, in which opening 28 is open. For pivoting the sealing element 30 between the open position and the sealed position, a discharge lever 64 is provided on the sealing element 30.

Further, as can be seen from FIG. 3, in the first pivot position of popping unit 6, base trough 12 is disposed in an indentation 60 of heating unit 4. In particular, an area of base trough 12 facing away from annular body 14 of base trough 12 is fully disposed in indentation 60. In the first pivot position of popping unit 6, base trough 12 rests in surface contact on a heating element 10 of heating unit 4. Heating element 10 is fixed to a housing 36 of heating unit 4 via bearings 46. The bearings 46 are configured such that they allow a movement of heating element 10 in the vertical direction of the popcorn machine, i.e., in the direction of popping unit 6 when it is in the first pivot position. To this end, bearings 46 each comprise one spiral spring. The bearings are disposed on a bearing plate 50, which is rigidly fixed to housing 36.

Furthermore, a gas spring 32 is provided in housing 36. A first end of gas spring 32 is supported on the housing. In particular, a first end of gas spring 32 is rotatably mounted on housing 36. On the second end, gas spring 32 is connected to popping unit 6, in particular annular body 14, via a deflection arrangement 48 in such a manner that gas spring 32 supports a pivoting of popping unit 6 from the first pivot position to the second pivot position, in particular as a result of gas spring 32 applying a force acting towards the second pivot position to popping unit 6. As a result, gas spring 32 also cushions a pivoting of popping unit 6 from the second pivot position to the first pivot position.

A pivot lever 38 is provided for pivoting the popping unit 6 between the first pivot position and the second pivot position. The pivot lever 38 is rotatably mounted on housing 36. A force acting on pivot lever 38 is transmitted to popping unit 6, in particular annular body 14, via deflection arrangement 48 or via an additional deflection arrangement.

A cooling fan 34 for cooling the hollow space defined by housing 36 is provided in housing 36.

Housing 36 comprises a maintenance gate 44. Maintenance gate 44 provides access to a hollow space defined by housing 36 for maintenance or assembly purposes.

The popcorn machine 2 further comprises a control unit, in particular in the form of a programmable logic controller (PLC). The programmable logic controller can store popcorn recipes. Furthermore, a temperature of the heating element 10 and a speed of the stirring unit 18 can be controlled by means of the programmable logic controller.

For example, the control unit is connected to the temperature sensor 70 in such a manner that the control unit controls the temperature of the heating element 10 while taking into account the temperature detected by the temperature sensor 70.

The programmable logic controller is connected to a control panel 40 in such a manner that information of the programmable logic controller can be displayed on the control panel 40. Furthermore, a user can enter information to be stored into the programmable logic controller via the control panel.

A central switch 42, by means of which the popcorn machine can be switched on and off, is provided on the housing 36.

### LIST OF REFERENCE SIGNS

2 popcorn machine
4 heating unit
6 popping unit
8 pivot bearing
10 heating element
12 base trough
14 annular body
16 lid
18 stirring unit
20 drive unit
22 drive shaft
24 stirring element
26 connecting element
28 opening
30 sealing element
32 gas spring
34 cooling fan
36 housing
38 pivot lever
40 control panel
42 central switch
44 maintenance gate
46 bearing(s)
48 deflection arrangement
50 bearing plate fixed to housing
52 discharge ramp
54 nut
56 fastening element receptacles
58 base trough handle
60 indentation
62 fastening element
64 discharge lever
66 hinge
68 thread screws
70 temperature sensor
72 spring element
74 guide pipe

1. A popcorn machine for producing popcorn from corn, the popcorn machine comprising a heating unit (4) with a heating element (10) and a popping unit (6), wherein the popping unit (6) is pivotably connected to the heating unit (4) via a pivoting unit in such a manner that the popping unit (6) is pivotable between a first pivot position, in which the popping unit (6) rests on the heating element (10) in particular, and a second pivot position, in which the popping unit (6) is spaced apart from the heating element (10), the popping unit (6) comprising a base trough (12) which is detachably fixed to an annular body (14) of the popping unit (6).

2. The popcorn machine according to claim 1, wherein in the first pivot position, the base trough (12) rests in surface contact on the heating element (10) or the base trough (12) is disposed in an indentation (60) of the heating unit (4).

3. The popcorn machine according to claim 1, wherein the heating element (10) is elastically mounted on a housing (36) of the heating unit (4).

4. The popcorn machine according to claim 1, wherein the pivoting unit engages with the annular body (14).

5. The popcorn machine according to claim 1, wherein the popping unit (6) comprises a lid (16) which is detachably fixed to the annular body (14) and which seals the annular body (14) on a side opposite the base trough (12).

6. The popcorn machine according to claim 1, wherein the popping unit (6) comprises a stirring unit (18) and a drive unit (20) for driving the stirring unit (18).

7. The popcorn machine according to claim 6, wherein the drive unit (20) is disposed on or in the lid (16).

8. The popcorn machine according to claim 1, wherein a temperature sensor (70) for measuring a temperature of the base trough (12), said temperature sensor (70) being movably disposed on the stirring unit (18) in such a manner that it is capable of making contact with the base trough (12).

9. The popcorn machine according to claim 8, wherein a spring element (72) which applies a force acting in the direction of the base trough (12) to the temperature sensor (70).

10. The popcorn machine according to claim 1, wherein the annular body (14) comprises an opening (28) for dispensing popcorn from the popping unit (6).

11. The popcorn machine according to claim 10, wherein the opening (28) is sealable with a sealing element (30), which is mounted on the lid (16) so as to be pivotable between a sealed position, in which the opening (28) is sealed, and an open position, in which the opening (28) is open.

12. The popcorn machine according to claim 11, wherein the sealing element (30) is mounted on the lid (16) in such a manner that by pivoting the popping unit (6) from the first position to the second position, the sealing element (30) is pivoted from the sealed position to the open position.

13. The popcorn machine according to claim 1, wherein a gas spring (32) for supporting a pivoting motion of the popping unit (6).

14. The popcorn machine according to claim 13, wherein a first end of the gas spring (32) is mounted on the heating unit (4), in particular on the housing (36) of the heating unit (4), and the second end of the gas spring (32) is connected to the popping unit (6) via a deflection arrangement (48).

15. The popcorn machine according to claim 1, wherein the heating unit (4) comprises a cooling fan (34).

16. The popcorn machine according to claim 1, wherein a programmable logic controller which stores popcorn recipes and by means of which the stored popcorn recipes are executable or by means of which a temperature of the heating element (10) or a speed of the stirring unit (18) is controllable.

17. The popcorn machine according to claim 16, wherein a control panel (40) which is connected to the programmable logic controller in such a manner that information of the programmable logic controller is displayable on the control panel (40) or information entered into the control panel (40) by the user is transmittable to the programmable logic controller.
